(19) United States
(12) Patent Application Publication
(10) Pub. No.: US 2009/0226031 A1
(43) Pub. Date: Sep. 10, 2009

(54) PARTICLE ANALYZER, METHOD FOR ANALYZING PARTICLES, AND COMPUTER PROGRAM PRODUCT

(75) Inventor: Munehisa IZUKA, Himeji (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION, Kobe-shi (JP)

(21) Appl. No.: 12/390,759

(22) Filed: Feb. 23, 2009

(30) Foreign Application Priority Data
Mar. 10, 2008 (JP) 2008-059646
Jan. 30, 2009 (JP) 2009-019563

(51) Int. Cl. G06K 9/00

(52) U.S. Cl. 382/100

(57) ABSTRACT

A particle analyzer capable of extracting particle image for each particle at high accuracy, if a plurality of images of a particle are imaged.

Concretely, a particle analyzer comprising a controller, including a memory under control of a processor, the memory storing instructions enabling the processor to carry out operations, comprising: acquiring extraction parameters for each particle based on each image of a particles; extracting particle images from each image of a particles based on the extraction parameters obtained for each particle; and analyzing particles based on the extracted particle image.

### FIELD OF THE INVENTION

The present invention relates to particle analyzers, methods for analyzing particles, and computer programs, and in particular, to a particle analyzer for analyzing particles based on an image including particles, a particle analyzing method for analyzing particles based on the image including particles, and a computer program for realizing the particle analyzing method.

### BACKGROUND

A particle analyzer including an extraction means for extracting a particle image from an imaged image is conventionally known (see e.g., US 2007-0273878).

US 2007-0273878 discloses a particle analyzer capable of obtaining morphological feature information such as size and shape of the particles contained in a sample liquid by imaging and analyzing particles contained in the sample liquid. In such particle analyzer, the particle image is extracted from the imaged image by using the difference in luminance between the background portion and the particle image portion of the imaged image. In other words, the particle image is extracted from the imaged image by setting a predetermined luminance value as a threshold value, and setting the portion which luminance is larger than the threshold value and the portion which luminance is smaller than the threshold value of the imaged image as the particle image portion and the background portion, respectively. The particle analyzer of US 2007-0273878 is configured to extract the respective particle image from each imaged image by setting one threshold value with respect to a plurality of imaged images obtained from one sample, and applying the threshold value to each imaged image.

However, since the particles are extracted based on the same threshold value with respect to the plurality of imaged images obtained from one sample in US 2007-0273878, if the imaged image obtained from one sample contains the particle image of large luminance and the particle image of small luminance, the error in extraction of the particle image of small luminance becomes large or may not be extracted if the threshold value is set so as to extract the particle image of large luminance with small error, that is, at high accuracy. Furthermore, if the threshold value is set so as to extract the particle image of small luminance at high accuracy, the error in extraction of the particle image of large luminance becomes large. Therefore, the particle analyzer of US 2007-0273878 has problems in that it is difficult to extract each particle image at small error, that is, at high accuracy over a plurality of particles in the sample.

### SUMMARY OF THE INVENTION

The scope of the invention is defined solely by the appended claims, and is not affected to any degree by the statements within this summary.

A first aspect of the invention is a particle analyzer comprising a controller, including a memory under control of a processor, the memory storing instructions enabling the processor to carry out operations, comprising: acquiring extraction parameters for each particle based on each image of a particles; extracting particle images from each image of a particles based on the extraction parameters obtained for each particle; and analyzing particles based on the extracted particle image.

A second aspect of the invention is a particle analyzer comprising: an extraction parameter acquiring means for acquiring extraction parameters for each particle based on each image of a particle; an extraction means for extracting particle images from the each image of a particle based on the extraction parameters obtained for each particle by the extraction parameter acquiring means; and an analyzing means for analyzing particles based on the particle image extracted by the extraction means.

A third aspect of the invention is method for analyzing particles comprising steps of: acquiring extraction parameters for each particle based on each image of a particle; extracting particle images from each image of a particle based on the extraction parameters obtained for each particle; and analyzing particles based on the particle images extracted by the extraction means.

A fourth aspect of the invention is a computer program product comprising: a computer readable medium; and instructions, on the computer readable medium, adapted to enable a particle analyzer to perform operations, comprising steps of: acquiring extraction parameters for each particle based on each image of a particle; extracting particle images from each image of a particle based on the extraction parameters obtained for each particle; and analyzing particles based on the particle images extracted by the extraction means.

### BRIEF DESCRIPTION OF THE DRAWINGS

FIG. 1 is a perspective view showing an overall configuration of a particle analyzer according to a first embodiment of the present invention;

FIG. 2 is a schematic view showing the overall configuration of the particle analyzer shown in FIG. 1;

FIG. 3 is a cross-sectional view for describing the flow of particle suspension liquid and sheath liquid in a flow cell of the particle analyzer shown in FIG. 2;

FIG. 4 is a plan view showing an internal structure of a particle image processing device of the particle analyzer shown in FIG. 1;

FIG. 5 is a plan view partially showing the particle image processing device shown in FIG. 4;

FIG. 6 is a front view of the particle image processing device shown in FIG. 5;

FIG. 7 is a schematic view for describing the principle of dark-field illumination;

FIG. 8 is a block diagram showing a configuration of the particle image processing device of the particle analyzer shown in FIG. 1;

FIG. 9 is a schematic view for describing the image processing operation of the particle analyzer shown in FIG. 1;

FIG. 10 is a flowchart showing the processing procedure of the image processing processor of the particle image processing device shown in FIG. 8;

FIG. 11 is a schematic view for describing a set value of a coefficient used in the Laplacian filter processing by a Laplacian filter processing circuit of the image processing processor shown in FIG. 8;

FIG. 12 is a luminance histogram of a case where bright-field illumination in the binarization processing of the image processing processor shown in FIG. 8 is performed;

FIG. 13 is a luminance histogram of a case where dark-field illumination in the binarization processing of the image processing processor shown in FIG. 8 is performed;

FIG. 14 is a schematic view showing content of a prime code data storage memory used in the prime code/multi-point information acquiring processing by the binarization processing circuit of the image processing processor shown in FIG. 8;

FIG. 15 is a schematic view for describing the definition of prime code used in the prime code/multi-point information acquiring processing by the binarization processing circuit of the image processing processor shown in FIG. 8;

FIG. 16 is a schematic view for describing the concept of the multi-point used in the prime code/multi-point information acquiring processing by the binarization processing circuit of the image processing processor shown in FIG. 8;

FIG. 17 is a schematic view for describing the determination principle on whether or not the inner particle image used in the overlap check processing by the overlap check circuit of the image processing processor shown in FIG. 8 exists;

FIG. 18 is a schematic view showing a configuration of one particle data in one frame data transmitted from the image processing substrate to the image data processing unit shown in FIG. 9;

FIG. 19 is a view for describing the rule when cutting out the partial image from the entire image of the particle by the image processing substrate shown in FIG. 9;

FIG. 20 is a flowchart showing the operation procedure of an image analysis processing module of the image data processing unit shown in FIG. 9;

FIG. 21 is a view showing a Sobel operator when calculating a gradient ΔX in a binarization processing of a image processing processor according to a second embodiment of the present invention;

FIG. 22 is a view showing a Sobel operator when calculating a gradient ΔY in the binarization processing of the image processing processor according to the second embodiment of the present invention;

FIG. 23 is an experiment result of example 1 in a comparative experiment for verifying the effects of the present invention;

FIG. 24 is an experiment result of example 2 in the comparative experiment for verifying the effects of the present invention; and

FIG. 25 is an experiment result of a comparative example in the comparative experiment for verifying the effects of the present invention.

### DETAILED DESCRIPTION OF THE PREFERRED EMBODIMENTS

Hereinafter, embodiments of a sample analyzer of the invention will be described in detail with reference to the accompanying drawings.

### First Embodiment

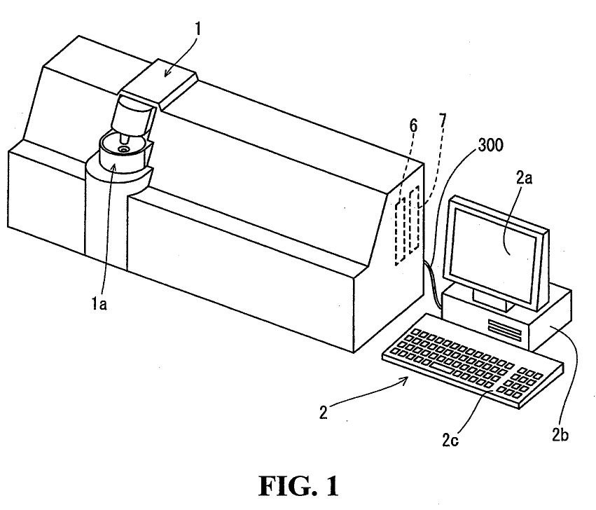

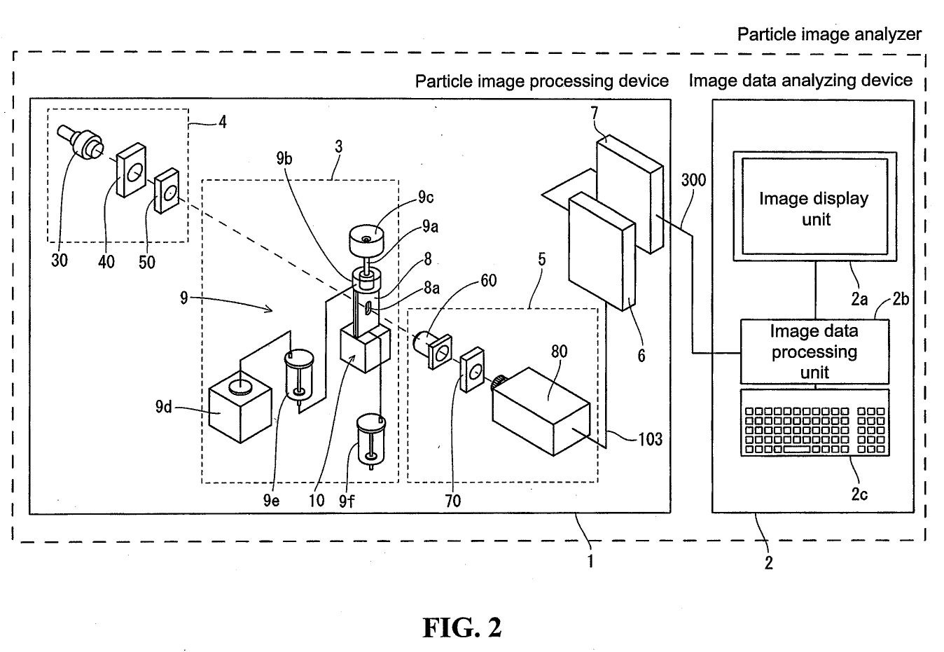

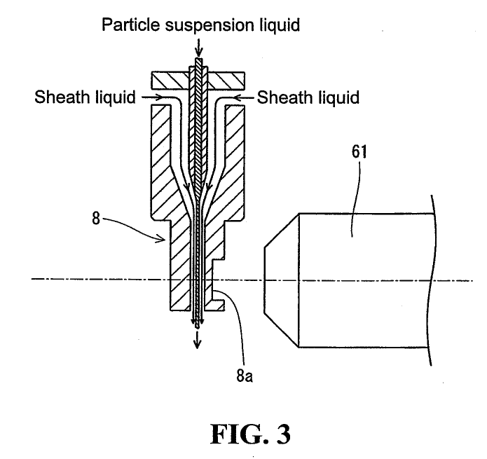

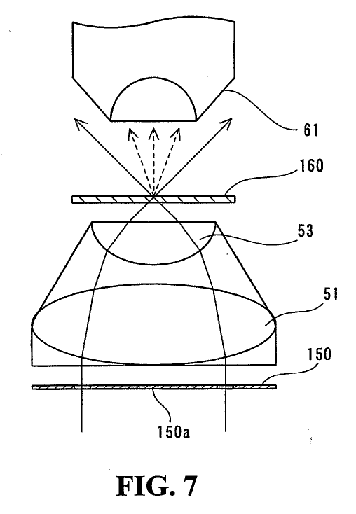

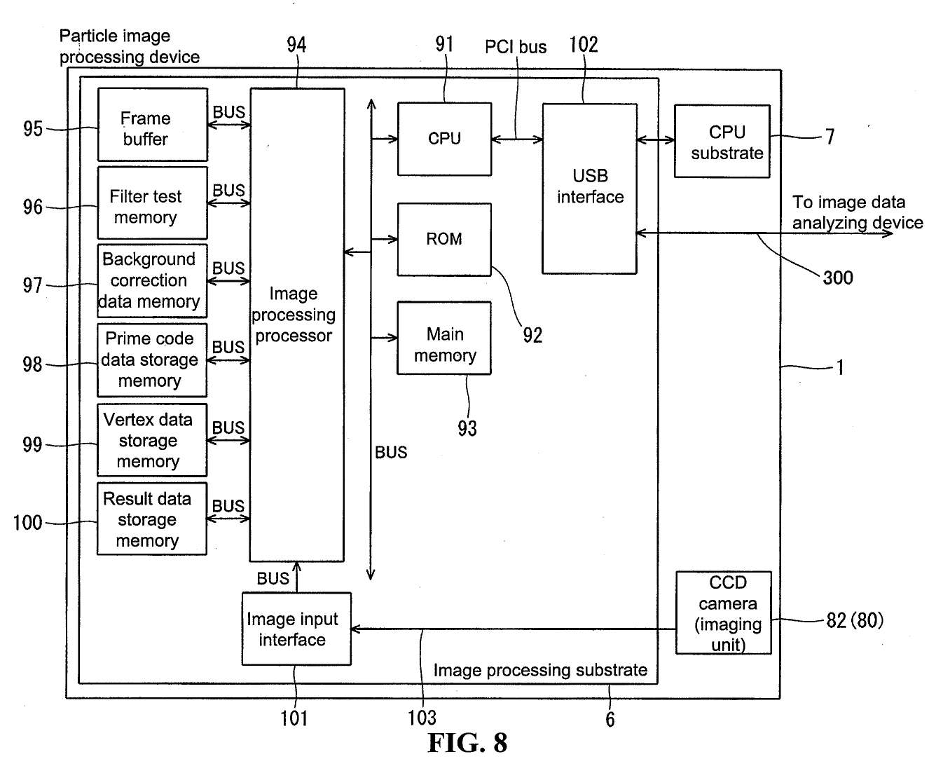

FIG. 1 is a perspective view showing an overall configuration of a particle analyzer according to a first embodiment of the present invention, and FIG. 2 is a schematic view showing the overall configuration of the particle analyzer shown in FIG. 1. FIGS. 3 to 6 are views for describing the structure of a particle image processing device of the particle analyzer shown in FIG. 1, and FIG. 7 is a view for describing the measurement principle of dark-field illumination. FIG. 8 is a block diagram showing a configuration of the particle image processing device of the particle analyzer shown in FIG. 1. The overall configuration of the particle analyzer according to the first embodiment of the present invention will be described first with reference to FIGS. 1 to 8.

The particle analyzer is used to manage the quality of fine ceramics particles, and powder such as pigment and cosmetic powder. As shown in FIGS. 1 and 2, the particle analyzer is configured by a particle image processing device 1, and an image data analyzing device 2 electrically connected to the particle image processing device 1 by means of an electric signal wire (in the first embodiment, USB (Universal Serial Bus) 2.0 cable) 300.

The particle image processing device 1 is arranged to perform the process of obtaining a still image by imaging the particles in the liquid, and analyzing the obtained still image to acquire morphological feature information (size, shape, and the like) of the particle image contained in the still image. The particles to be analyzed by such particle image processing device 1 include fine ceramic particles, and powder such as pigment and cosmetic powder. As shown in FIG. 1, the particle image processing device 1 is entirely covered with a cover 1a. This cover 1a has a light shielding function, and is attached at the inner surface with a heat insulating material (not shown) to maintain heat.

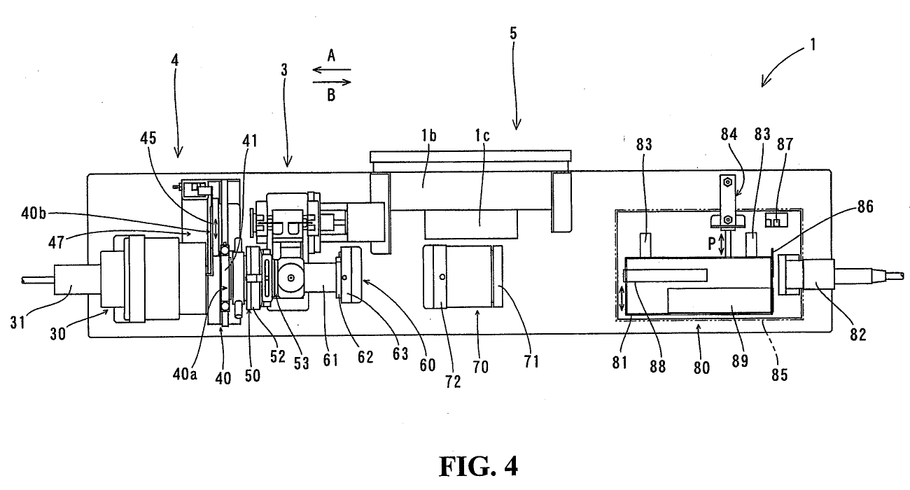

As shown in FIG. 4, the particle image processing device 1 is attached with a Peltier element 1b and a fan 1c for maintaining the interior covered with the cover 1a (see FIG. 1) of the particle image processing device 1 at a predetermined temperature (about 25° C.). By maintaining the interior of the particle image processing device 1 at the predetermined temperature (about 25°) by the cover 1a, the Peltier element 1b, and the fan 1c, shift in focal length in time of imaging caused by change in temperature, and change in characteristics such as viscosity and specific gravity of the sheath liquid, to be hereinafter described, can be suppressed.

In the particle image processing device 1 according to the first embodiment, switch can be made to either the bright-field illumination or the dark-field illumination depending on the measuring target when imaging the particles. For instance, the particles are imaged at the dark-field illumination if the measuring target is a transparent particle or close-to-transparent particle (translucent particle), and the particles are imaged at the bright-field illumination if the measuring target is an opaque particle.

The image data analyzing device 2 is arranged to automatically calculate and display the morphological feature information such as size and shape of the particles by storing and analyzing the still image processed by the particle image processing device 1. As shown in FIGS. 1 and 2, the image data analyzing device 2 comprises a personal computer (PC) including an image display unit (display) 2a for displaying the still image, and a keyboard 2c.

As shown in FIG. 2, the particle image processing device 1 includes a fluid mechanism section 3 for forming a flow of particle suspension liquid; an illumination optical system 4 for irradiating light on the flow of particle suspension liquid; an imaging optical system 5 for imaging the flow of particle suspension liquid; an image processing substrate 6 for performing a cutout process, and the like of a partial image (particle image) from the still image imaged by the imaging optical system 5; and a CPU substrate 7 for performing control of the particle image processing device 1. The illumination optical system 4 and the imaging optical system 5 are arranged at opposing positions with the fluid mechanism section 3 in between.

The fluid mechanism section 3 includes a transparent flow cell 8 made of quartz, a supply mechanism unit 9 for supplying the particle suspension liquid and the sheath liquid to the flow cell 8, and a support mechanism unit 10 for supporting the flow cell 8. The flow cell 8 has a function of converting the flow of particle suspension liquid to a flat flow by sandwiching both sides of the particle suspension liquid with the flow of the sheath liquid. As shown in FIGS. 2 and 3, the flow cell 8 has a vertically long recess 8a in the vicinity of the central position of the outer surface on the imaging optical system 5 side of the flow cell 8. The particle suspension liquid flowing through the flow cell 8 is imaged through the recess 8a of the flow cell 8.

As shown in FIG. 2, the supply mechanism unit 9 includes a supply portion 9b with a sample nozzle 9a (see FIG. 2) for supplying the particle suspension liquid to the flow cell 8, a supply port 9c for feeding the particle suspension liquid to the supply portion 9b, a sheath liquid container 9d for storing the sheath liquid, a sheath liquid chamber 9e for temporarily storing the sheath liquid, and a discard chamber 9f for storing the sheath liquid that has passed the flow cell 8.

As shown in FIGS. 2 and 4, the illumination optical system 4 is configured by an irradiation unit 30, a light reducing unit 40 installed on the flow cell 8 side than the irradiation unit 30, and a light collecting unit 50 installed on the flow cell 8 side than the light reducing unit 40. The irradiation unit 30 is arranged to irradiate light towards the flow cell 8.

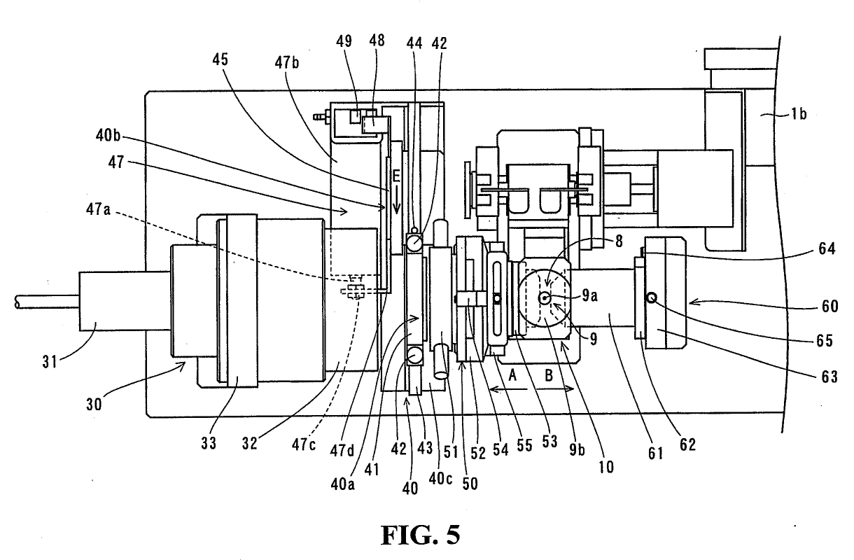

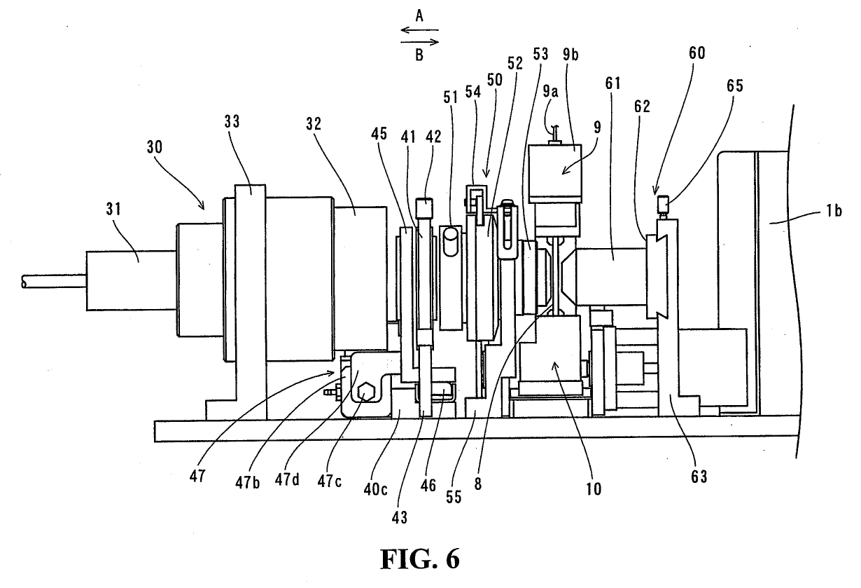

As shown in FIGS. 5 and 6, the irradiation unit 30 includes a lamp 31 serving as a light source, a field stop 32, and a bracket 33 for supporting the lamp 31 and the field stop 32. The field stop 32 is arranged to adjust the range of field that can be imaged by an imaging unit 80. The light emitting voltage of the lamp 31 is controlled by the image data analyzing device 2.

The lamp 31 periodically irradiates the pulse light at every 1/60 seconds when imaging the particles. Thus, the still images for 60 frames are imaged in one second. In the normal measurement, the still images for 3600 frames are imaged in one minute in one measurement.

The light reducing unit 40 is arranged to adjust the intensity of light by reducing the light from the irradiation unit 30. As shown in FIG. 5, the light reducing unit 40 includes a fixed light reducing portion 40a fixedly attached to the irradiation unit 30, a movable light reducing portion 40b movably attached in the Y direction with respect to the irradiation unit 30, and a bracket 40c for supporting the fixed light reducing portion 40a and the movable light reducing portion 40b.

As shown in FIGS. 5 and 6, the fixed light reducing portion 40a includes a fixed light reducing filter 41, two long screws 42, a rail member 43, and a positioning pin 44. The fixed light reducing filter 41 is detachably configured with respect to the rail member 43 so as to be changeable with another fixed light reducing filter 41 with different light reduction rate. The two long screws 42 are arranged to attach the fixed light reducing filter 41 to the rail member 43. The positioning pin 44 has a function of positioning the fixed light reducing filter 41 with respect to the rail member 43. In the first embodiment, the fixed light reducing filter 41 of the fixed light reducing portion 40a is detached when performing imaging by the dark-field illumination in order to ensure sufficient light quantity in time of imaging by the dark-field illumination.

As shown in FIGS. 5 and 6, the movable light reducing portion 4b includes a movable light reducing filter 45, a drive mechanism unit 47 for moving the movable light reducing filter 45 along a linear movement guide 46 (see FIG. 6), a detection piece 48 (see FIG. 5) attached to the movable light reducing filter 45, and a light transmissive sensor 49, attached to the bracket 40c, for detecting the detection piece 48. The movable light reducing filter 45 is installed on the irradiation unit 30 side than the fixed light reducing portion 40a, and is configured to be movable between an operating position at which the light from the irradiation unit 30 can be reduced and a retreated position at which the light from the irradiation unit 30 is not influenced. The drive mechanism unit 47 includes an air cylinder 47b, serving as a drive source, with a piston rod 47a, and a drive transmission member 47d connected to the piston rod 47a of the air cylinder 47b by way of a coupling member 47c. The drive transmission member 47d is attached to the movable light reducing filter 45. The movable light reducing filter 45 is attached so as not to be easily changed with another movable light reducing filter 45 of different light reduction rate, as opposed to the fixed light reducing filter 41. The movable light reducing filter 45 is used to adjust the light quantity in magnification switching by a relay lens (lens 88 and lens 89), to be hereinafter described.

The light collecting unit 50 is arranged to collect the light reduced by the light reducing unit 40 towards the flow cell 8. As shown in FIGS. 5 and 6, the light collecting unit 50 includes an auxiliary lens 51, an aperture stop 52 installed on the flow cell 8 (see FIG. 6) side than the auxiliary lens 51, a capacitor lens 53 installed on the flow cell 8 side than the aperture stop 52, a stop adjuster 54 for adjusting the numerical aperture of the aperture stop 52, and a bracket 55. The aperture stop 52 is arranged to adjust the quantity of light from the irradiation unit 30 side. When performing the dark-field illumination, the aperture of the aperture stop 52 is set to be a maximum by the stop adjuster 54.

As shown in FIG. 7, in the first embodiment, a ring slit 150 having a light shielding portion 150a at the central part is attached to the auxiliary lens 51 when performing the dark-field illumination. This can prevent the light irradiated from the lamp 31 from directly entering an objective lens 61. The light shielding portion 150a of the ring slit 150 is set with a minimum size the light does not directly enter the objective lens 61. The opening portion (slit portion) thus becomes large, and the light of a quantity necessary for imaging can be irradiated on the particles.

The measurement principle of the dark-field illumination will now be described. As shown in FIG. 7, in the dark-field illumination, the light collected by the capacitor lens 53 is prevented from directly entering the objective lens 61 by attaching the ring slit 150 to the auxiliary lens 51. In other words, in the dark-field illumination, only the light diffracted by impacting the sample (particle) 160 enters the objective lens 61, thereby forming a sample image (particle image). The light that does not impact the sample (particle) 160 does not enter the objective lens 61, and thus the background appears dark (has small luminance value) compared to the sample image (particle image). When imaging a transparent particle or a translucent particle, the dark-field illumination is preferably used since the difference in luminance value between the background and the particle image of the imaged image in the dark-field illumination becomes larger than the difference in luminance value between the background and the particle image of the imaged image in the bright-field illumination.

In the bright-field illumination, the ring slit 150 (see FIG. 7) is detached so that the light shielded by impacting the sample (particle) does not enter the objective lens 61 or enters the objective lens with weakened intensity. The light that does not impact the sample (particle) directly enters the objective lens 61. Therefore, in the bright-field illumination, the background of the imaged image appears brighter (has large luminance value) than the sample image (particle image).

As shown in FIGS. 2 and 4, the imaging optical system 5 is configured by an objective lens unit 60, an imaging lens unit 70, and an imaging unit 80.

The objective lens unit 60 is arranged to enlarge the light image of the particles in the particle suspension liquid flowing through the flow cell 8 (see FIG. 6) irradiated with light from the illumination optical system 4. As shown in FIGS. 5 and 6, the objective lens unit 60 includes the objective lens 61, an objective lens holder 62 for holding the objective lens 61, a bracket 63 for supporting the objective lens holder 62, a positioning pin 64 (see FIG. 5), and a fixing screw 65.

As shown in FIG. 4, the imaging lens unit 70 includes an imaging lens 71 for imaging the light image of the particles enlarged by the objective lens unit 60, and a bracket 72 for holding the imaging lens 71.

The imaging unit 80 is arranged to image the particle image imaged by the imaging lens unit 70. As shown in FIG. 4, the imaging unit 80 includes a relay lens box 81, a CCD camera 82, a drive mechanism unit 84 for sliding the relay lens box 82 in a P direction of FIG. 4 along two linear movement guides 83, a light shielding cover 85 for covering the imaging unit 80, a detection piece 86 attached to the relay lens box 81, and a light transmissive sensor 87 for detecting the detection piece 86. A lens 88 having an enlargement magnification of two times and a lens 89 having an enlargement magnification of 0.5 times are built in the relay lens box 81. The lens 88 having an enlargement magnification of two times and the lens 89 having an enlargement magnification of 0.5 times are interchanged by sliding the relay lens box 81 in the P direction.

The configuration of the image processing substrate 6 will now be described with reference to FIGS. 2 and 8. As shown in FIG. 8, the image processing substrate 6 is configured by a CPU 91, a ROM 92, a main memory 93, an image processing processor 94, a frame buffer 95, a filter test memory 96, a background correction data memory 97, a prime code data storage memory 98, a vertex data storage memory 99, a result data storage memory 100, an image input interface 101, and a USB interface 102. The CPU 91, the ROM 92, the main memory 93, and the image processing processor 94 are connected by a bus so that data can be transmitted and received with each other. The image processing processor 94 is connected to the frame buffer 95, the filter test memory 96, the background correction data memory 97, the prime code data storage memory 98, the vertex data storage memory 99, the result data storage memory 100, and the image input interface 101 by an individual bus. Read and write of data from the image processing processor 94 to the frame buffer 95, the filter test memory 96, the background correction data memory 97, the prime code data storage memory 98, the vertex data storage memory 99, and the result data storage memory 100 thus become possible, and input of data from the image input interface 101 to the image processing processor 94 becomes possible. The CPU 91 of such image processing substrate 6 is connected to the USB interface 102 by way of a PCI bus. The USB interface 102 is connected to the CPU substrate 7 by way of a USB/RS-232c converter (not shown).

The CPU 91 has a function of executing computer programs stored in the ROM 92, and computer programs loaded in the main memory 93. The ROM 92 is configured by a mask ROM, PROM, EPROM, EEPROM, and the like. The ROM 92 is recorded with computer programs to be executed by the CPU 51a, data used for the computer programs, and the like. The main memory 93 is configured by SRAM or DRAM. The main memory 93 is used to read out the computer program recorded on the ROM 92, and is used as a work region of the CPU 91 when the CPU 91 executes the computer program.

The image processing processor 94 is configured by FPGA (Field Programmable Gate Array), ASIC (Application Specific Integrated Circuit), and the like. The image processing processor 94 is a processor dedicated to image processing including hardware capable of executing image processing such as median filter processing circuit, Laplacian filter processing circuit, binarization processing circuit, edge trace processing circuit, overlap check processing circuit, and result data creating circuit. The frame buffer 95, the filter test memory 96, the background correction data memory 97, the prime code data storage memory 98, the vertex data storage memory 99, and the result data storage memory 100 are respectively configured by SRAM, DRAM, or the like. Such frame buffer 95, the filter test memory 96, the background correction data memory 97, the prime code data storage memory 98, the vertex data storage memory 99, and the result data storage memory 100 are used for storing data when the image processing processor 94 executes image processing.

The image input interface 101 includes a video digitize circuit (not shown) including an A/D converter. As shown in FIGS. 2 and 8, the image input interface 101 is electrically connected to a CCD camera 82 (imaging unit 80) by a video signal cable 103. The video signal input from the CCD camera 82 is A/D converted by the image input interface 101 (see FIG. 8). The digitized image data of the still image is stored in the frame buffer 95. The USB interface 102 is connected to the CPU substrate 7 by way of the USB/RS-232c converter (not shown). The USB interface 102 is connected to the image data analyzing device 2 by the electrical signal wire (USB 2.0 cable) 300. The CPU substrate 7 is configured by CPU, ROM, RAM, and the like, and has a function of controlling the particle image processing device 1.

As shown in FIGS. 1 and 2, the image data analyzing device 2 is configured by a personal computer (PC) including an image display unit 2a, an image data processing unit 2b serving as a device body equipped with CPU, ROM, RAM, hard disc, and the like, and an input device 2c such as keyboard. The hard disc of the image data processing unit 2b is installed with an application program for performing analysis processing and statistical processing of the image data based on the processing result in the particle image processing device 1 by communicating with the particle image processing device 1. The application program is configured to be executed by the CPU of the image data processing unit 2b.

The operation of the particle image processing device 1 according to the first embodiment of the present invention will be described below with reference to FIGS. 2, 3, 4, 8, and 9.

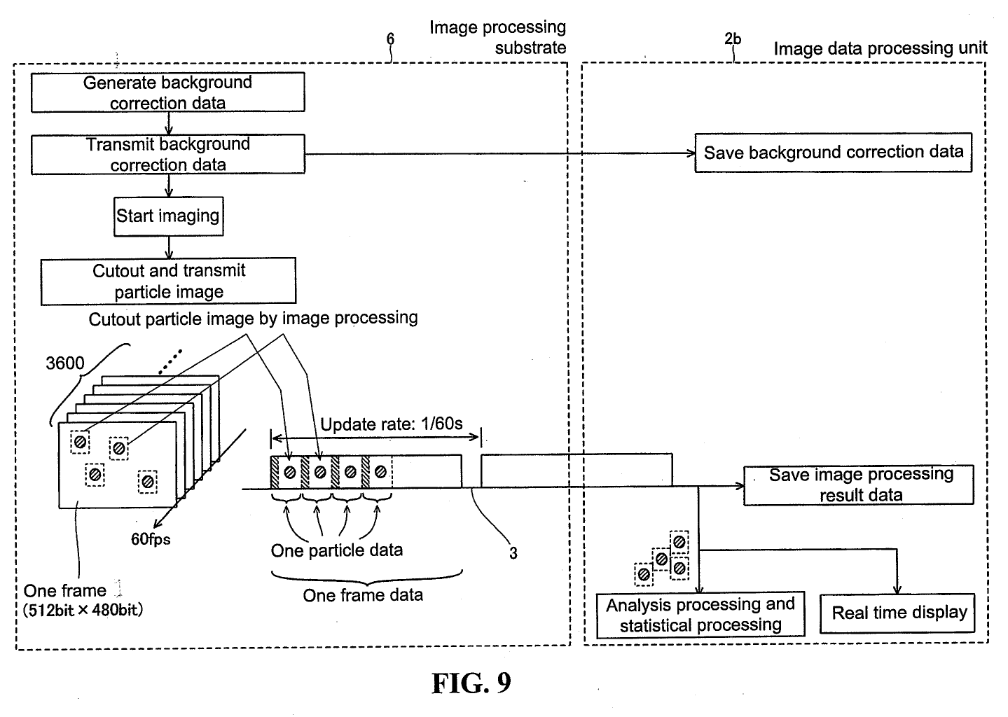

First, after performing focus adjustment of the imaging optical system 5, adjustment of strobe light emission intensity of the lamp 31 is performed. Thereafter, imaging of a background correction image for generating background correction data is performed. Specifically, the lamp 31 periodically irradiates the pulse light every 1/60 seconds and the CCD camera 82 performs imaging with only the sheath liquid supplied to the flow cell 8. The still image (background correction image) for every 1/60 seconds in a state the particles are not passing through the flow cell 8 is imaged by the CCD camera 82 through the objective lens 61. A plurality of background correction images without the particles is retrieved to the image processing substrate 6. One background correction data is thereby generated, as shown in FIG. 9. In the image processing substrate 6, the background correction data is stored in the background correction data memory 97 (see FIG. 8), and transmitted to the image data processing unit 2b of the image data analyzing device 2 through the electrical signal wire (USB 2.0 cable) 300. On the image data analyzing device 2 side, the received background correction data is saved in a memory of the image data processing unit 2b. The process of generating the background correction data is executed only once before the start of imaging of the particles.

The particles are then imaged. Specifically, the particle suspension liquid supplied to the supply port 9c shown in FIG. 2 is sent to the supply portion 9b positioned on the upper side of the flow cell 8. The particle suspension liquid of the supply portion 9b is gradually pushed out into the flow cell 8 from the distal end of the sample nozzle 9a (see FIG. 2) arranged in the supply portion 9b. The sheath liquid is also sent into the flow cell 8 from the sheath liquid container 9d through the sheath liquid chamber 9e and the supply portion 9b. As shown in FIG. 3, the particle suspension liquid flows from the upper side to the lower side in the flow cell 8 while being squeezed to a hydrodynamic flat shape by being sandwiched with the sheath liquid from both sides. As shown in FIG. 2, the particle suspension liquid is discharged through the discard chamber 9f after passing through the flow cell 8. As described above, the image of the particles is imaged by the imaging unit 80 through the objective lens unit 60 in the imaging optical system 5 by irradiating light from the irradiation unit 30 of the illumination optical system 4 onto the flow of the particle suspension liquid squeezed to a flat shape in the flow cell 8 of the fluid mechanism section 3.

In this case, the lamp 31 (see FIG. 4) periodically irradiates the pulse light every 1/60 on the flow of the particle suspension liquid squeezed flat in the flow cell 8. The irradiation of pulse light from the lamp 31 is performed for 60 seconds. A total of 3600 still images are imaged by the CCD camera 82 through the objective lens 61.

The distance between the center of gravity of the particle to be imaged and the imaging surface of the CCD camera 82 of the imaging unit 80 can be made substantially constant by imaging the flat plane of the flow of particle suspension liquid with the imaging unit 80. Thus, a still image focused on the particle is always obtained irrespective of the size of the particle.

The still image imaged by the CCD camera 82 is output to the image processing substrate 6 (see FIG. 8) as a video signal via the video signal cable 103. In the image input interface 101 of the image processing substrate 6, the digitized image data is generated from the imaged image by performing A/D conversion on the video signal from the CCD camera 82 (see FIG. 8). The image data is a gray scale image. The image data output by the image input interface 101 shown in FIG. 8 is transferred and stored in the frame buffer 95 (series of image data to be stored in the frame buffer 95 is referred to as frame data). As shown in FIG. 9, the cutout process (extraction) from the imaged image including a plurality of particles to a partial image including a single particle by the image processing substrate 6, and the transmission of the image processing result data to the image data processing unit 2b are performed on the frame data stored in the frame buffer 95. In this case, the following image processing by the image processing processor 94 (see FIG. 8) of the image processing substrate 6 is first executed.

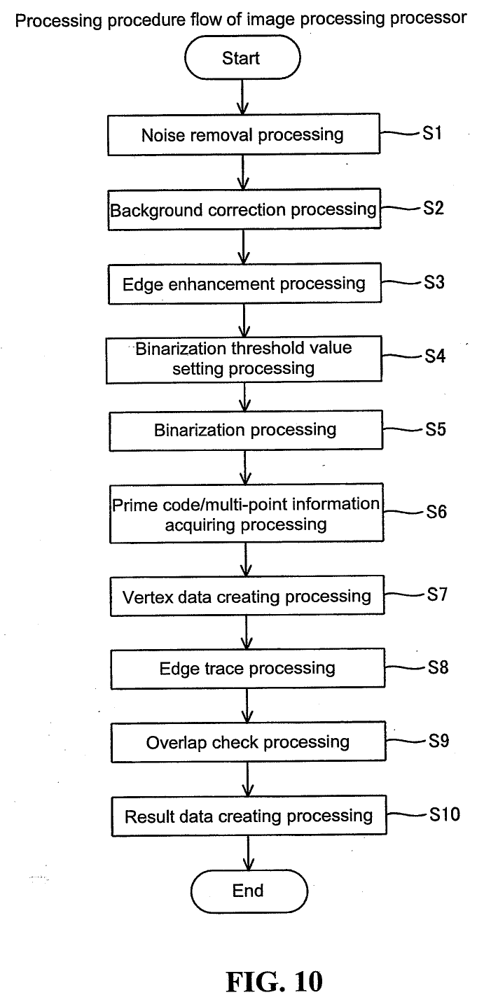

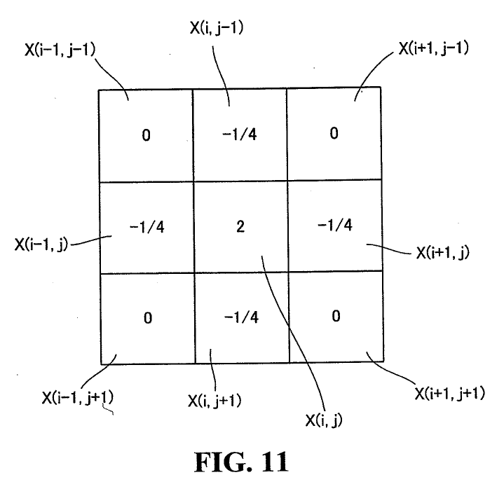

FIG. 10 is a flowchart showing a processing procedure of the still image of the image processing processor of the particle image processing device according to the first embodiment shown in FIG. 8. FIGS. 11 to 19 are views for describing the processing method of the still image of the image processing processor of the particle image processing device according to the first embodiment shown in FIG. 8. The processing method of the still image of the image processing processor 94 of the particle image processing device 1 according to the first embodiment will be described below with reference to FIGS. 8 to 19.

As for the image processing by the image processing processor 94, the image processing processor 94 executes noise removal processing on the still image (image data) stored in the frame buffer 95 in step S1. That is, the image processing processor 94 is arranged with a median filter processing circuit, as mentioned above. Through the median filter processing by the median filter processing circuit, noise such as dust in the still image is removed. The median filter processing is a process, with respect to a total of nine pixels including the pixel of interest and the eight pixels at the vicinity thereof, of lining each luminance value in order of large (or small) numbers and setting a median (intermediate value) of the pixel values of nine pixels as a luminance value of the pixel of interest.

In step S2, the image processing processor 94 executes a background correction process for correcting intensity variation of the irradiation light on the flow of particle suspension liquid. That is, the image processing processor 94 is arranged with a Laplacian filter processing circuit, as mentioned above. In the background correction process, a comparison calculation between the background correction data acquired in advance and stored in the background correction data memory 97 and the still image after the median filter processing is performed by the Laplacian filter processing circuit, and the majority of the background image is removed from the still image.

In step S3, the image processing processor 94 executes an edge enhancement process. In the edge enhancement process, the Laplacian filter processing is performed by the Laplacian filter processing circuit. The Laplacian filter processing is a process, with respect to a total of nine pixels including the pixel of interest and the eight pixels at the vicinity thereof, multiplying each luminance value and a corresponding predetermined coefficient, and setting the sum of the multiplication result as the luminance value of the pixel of interest. As shown in FIG. 11, assume the coefficient corresponding to the pixel of interest X(i, j) is “2”, and the coefficient corresponding to four pixels (i, j−1), X(i, j+1), X(i−1, j), and X(i+1, j) adjacent with the pixel of interest in the up and down and left and right directions is “−¼”, and the coefficient corresponding to four pixels X(i−1, j−1), X(i+1, j−1), X(i+1, j+1), and X(i−1, j+1) adjacent with the pixel of interest in the diagonal direction is “0”. The luminance value Y(i, j) of the pixel of interest after the Laplacian filter processing is calculated from the following equation (1). Here, 255 is output if the result of the calculation by the following equation (1) is greater than 255, and 0 is output if the result of the calculation by equation (1) is a negative number.

Y(i, j)=2×X(i, j)−0.25×(X(i, j−1)+X(i−1, j)+X(i, j+1)+X(i+1, j))+0.5 (1)

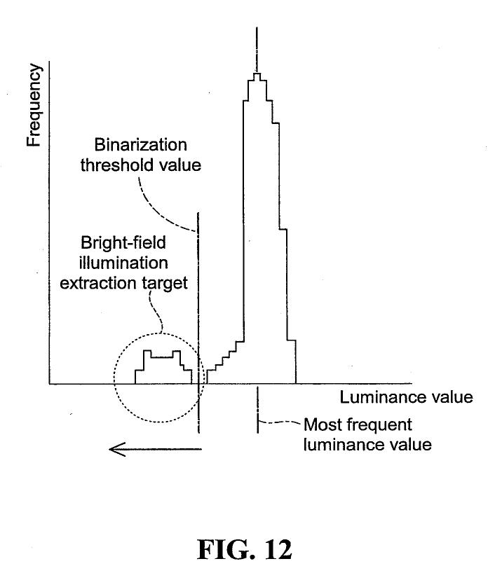

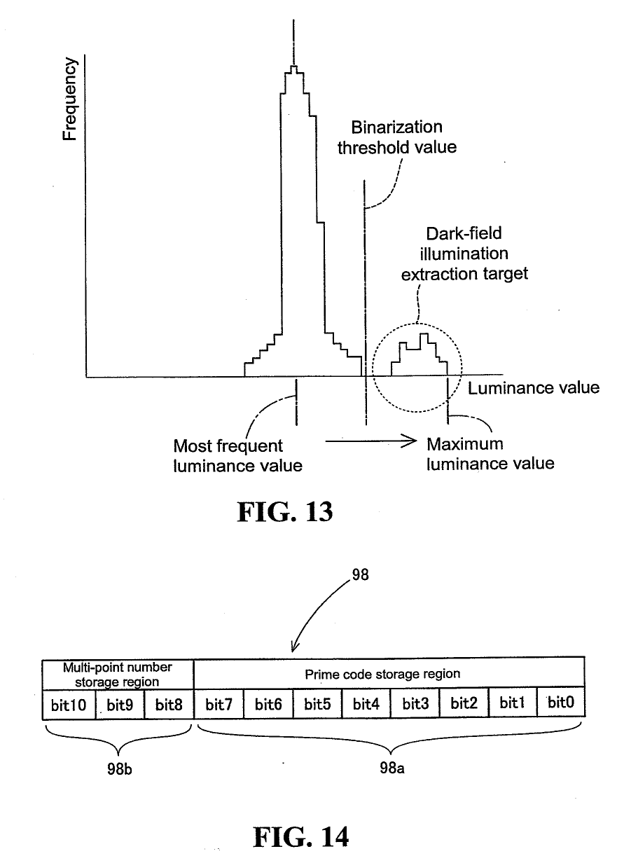

In step S4, the image processing processor 94 sets a binarization threshold value based on the data after the edge enhancement process has been performed. In other words, the Laplacian filter circuit of the image processing processor 94 is arranged with a luminance histogram portion executing the binarization threshold value setting processing. First, the image processing processor 94 creates a luminance histogram (see FIGS. 12 and 13) from the image data after the Laplacian filter processing. FIG. 12 shows the luminance histogram of the still image by the bright-field illumination, and FIG. 13 shows the luminance histogram of the still image by the dark-field illumination. The image processing processor 94 performs a predetermined smoothing processing on the luminance histogram. With respect to the still image by the bright-field illumination, the most frequent luminance value of the still image is obtained from the luminance histogram after the smoothing processing, and thereafter, the binarization threshold value is calculated by the following equation (2) by using the most frequent luminance value.

Binarization threshold value=most frequent luminance value of still image×α(0<α<1)+β (2)

In equation (2), α and β are variables that can be set by the user, and the user can change the values of α and β depending on the measuring target. The default value of α and β is “0.9” and “0”, respectively.

In the first embodiment, the binarization threshold value is calculated as below with respect to the still image by the dark-field illumination. First, the most frequent luminance value is obtained from the luminance histogram after the smoothing processing. The maximum luminance value of the still image is determined by referencing the luminance values of all pixels of the still image. The binarization threshold value is calculated by the following equations (3) and (4) by using the most frequent luminance value and the maximum luminance value of the still image.

Binarization threshold value=most frequent luminance value of still image+maximum luminance value of still image×γ(0<γ<1) (3)

Binarization threshold value=most frequent luminance value of still image+δ (4)

Equation (3) is applied in the case of maximum luminance value of still image×γ>δ, and equation (4) is applied in the case of maximum luminance value of still image×γ≦δ. That is, the binarization threshold value is essentially calculated from equation (3), but if the calculation value of equation (3) becomes smaller than the calculation value of equation (4) as the particle image of the still image is dark, the calculation value of the equation (4) is set as the binarization threshold value. In equations (3) and (4), γ and δ are variables that can be set by the user, and the user can change the values of γ and δ depending on the measuring target. The threshold value for extracting the particles can be calculated in accordance with the luminance (brightness) of each particle by calculating the binarization threshold value by equation (3).

In step S5, the image processing processor 94 performs a binarization processing on the still image after the Laplacian filter processing at the threshold level (binarization threshold value) set in the binarization threshold value setting processing. That is, a collection of pixels having a luminance value smaller than the value calculated in equation (2) is specified as a particle image with respect to the still image by the bright-field illumination. A collection of pixels having a luminance value greater than the value calculated in equation (3) or equation (4) is specified as a particle image with respect to the still image by the dark-field illumination.

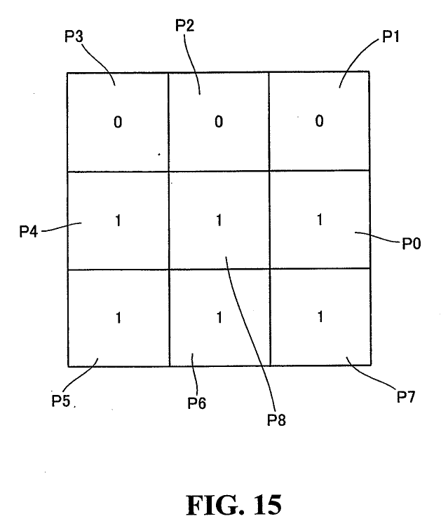

In step S6, the prime code and multi-point information are acquired with respect to each pixel of the image performed with the binarization processing. That is, the image processing processor 94 is arranged with a binarization processing circuit. The binarization processing and the prime code/multi-point information acquiring processing are executed by the binarization processing circuit. The prime code is a binarization code obtained for a total of nine pixels including the pixel of interest and the eight pixels at the vicinity thereof, and is defined as below. As shown in FIG. 14, the prime code data storage memory 98 includes two regions, a prime code storage region 98a and a multi-point number storage region 98b, in one word (eleven bits). The prime code storage region 98a is a region of eight bits indicated by bit 0 to bit 7 in FIG. 14, and the multi-point number storage region 98b is a region of three bits indicated by bit 8 to bit 10 in FIG. 14. The definition of the prime code will now be described. As shown in FIG. 15, the pixel values of P1 to P3 are 0, and the pixel values of P0 and P4 to P8 are 1 with respect to the nine pixels of P0 to P8 of the binarization processed image data. The pixel values of P0 to P8 become 1 when the luminance value respectively corresponding to the nine pixels of P0 to P8 is greater than or equal to the binarization threshold value, and the pixel values of P0 to P8 become 0 when the luminance value respectively corresponding to the nine pixels of P0 to P8 is smaller than the binarization threshold value. The prime code in this case will be described. The eight pixels P0 to P7 other than the pixel of interest P8 each corresponds to bit 0 to bit 7 of the prime code storage region 98a. That is, the prime code storage region 98a is configured so that the pixel values of the eight pixels P0 to P7 are respectively stored from the lower order bit (bit 0) towards the higher order bit (bit 7). The prime code is thus 11110001 in binary number representation, and is F1 in hexadecimal number representation. The pixel value of the pixel of interest P8 is not included in the prime code.

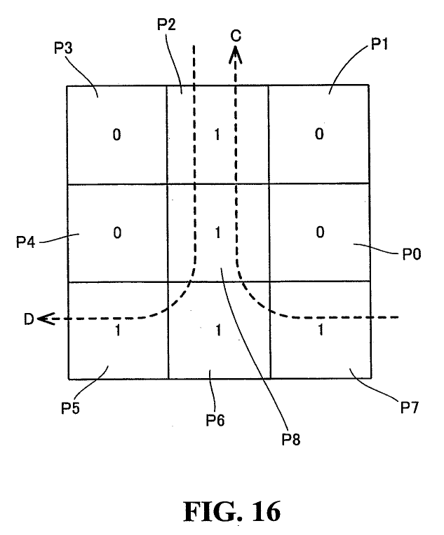

If the region configured by the pixel of interest and the eight pixels at the vicinity thereof is part of the boundary of the particle image, that is, if the prime code is other than 00000000 in binary number representation, the multi-point information is obtained. The multi-point is the code indicating the number of times it may be passed in edge trace, to be hereinafter described, and the multi-point information corresponding to all patterns are stored in the lookup table (not shown) in advance. The number of multi-points is obtained by referencing the lookup table. With reference to FIG. 16, if the pixel values of the four pixels of P2 and P5 to P8 are one, and the pixel values of four pixels of P0, P1, and P3 are 0, the pixel of interest P8 has a possibility of being passed twice in edge trace, as shown with arrows C and D in FIG. 16. Therefore, the pixel of interest P8 is a dual point, and the number of multi-points is two. The number of multi-points is stored in the multi-point number storage region 98b.

In step S7, the image processing processor 94 creates vertex data. The vertex data creating process is also executed by the binarization processing circuit arranged in the image processing processor 94, similar to the binarization processing and the prime code/multi-point information acquiring processing, as mentioned above. The vertex data is the data indicating the coordinate scheduled to start the edge trace, to be hereinafter described. The region of a total of nine pixels including the pixel of interest and the eight pixels at the vicinity thereof are judged as the vertex only when the following three conditions (condition (1) to condition (3)) are all met.

Condition (1) . . . Pixel value of pixel of interest P8 is one.

Condition (2) . . . Pixel values of the three pixels (P1 to P3) on the upper side of the pixel of interest P8 and one pixel (P4) on the left of the pixel of interest P8 are zero.

Condition (3) . . . Pixel values of one pixel (P0) on the right of the pixel of interest P8, and at least one of the three pixels (P5 to P7) on the lower side of the pixel of interest P8 are one.

The image processing processor 94 searches for the pixel corresponding to the vertex from all the pixels, and stores the created vertex data (coordinate data indicating the position of the vertex) in the vertex data storage memory 99.

In step S8, the image processing processor 94 executes the edge trace processing. The image processing processor 94 is arranged with an edge trace processing circuit, and the edge trace processing is executed by the edge trace processing circuit. In the edge trace processing, the coordinate to start the edge trace is first specified from the vertex, and the edge trace of the particle image is performed from the coordinate based on the prime code and the code for determining the advancing direction stored in advance. The image processing processor 94 calculates the area value, the number of straight counts, the number of oblique counts, the number of corner counts, and the position of each particle image in edge trace. The area value of the particle image is the total number of pixels configuring the particle image, that is, the total number of pixels contained on the inner side of the region surrounded by edges. The number of straight counts is the total number of edge pixels excluding the edge pixels at both ends of a linear zone when the edge pixels of three or more pixels of the particle image are linearly lined in the up and down direction or the left and right direction. In other words, the number of straight counts is the total number of edge pixels configuring a linear component extending in the up and down direction or the left and right direction of the edges of the particle image. The number of oblique counts is the total number of edge pixels excluding the edge pixels at both ends of a linear zone in the oblique direction when the edge pixels of three or more pixels of the particle image are linearly lined in the oblique direction. In other words, the number of oblique counts is the total number of edge pixels configuring the linear component extending in the oblique direction of the edges of the particle image. The number of corner counts is the total number of edge pixels where a plurality of adjacent edge pixels contact in different directions (e.g., when adjacent to one edge pixel at the upper side and adjacent to the other edge pixel at the left side) of the edge pixels of the particle image. In other words, the number of corner counts is the total number of edge pixels configuring the corner of the edges of the particle image. The position of the particle image is determined by the coordinates of the right end, the left end, the upper end, and the lower end of the particle image. The image processing processor 94 stores the data of the calculation result in an internal memory (not shown) incorporated in the image processing processor 94.

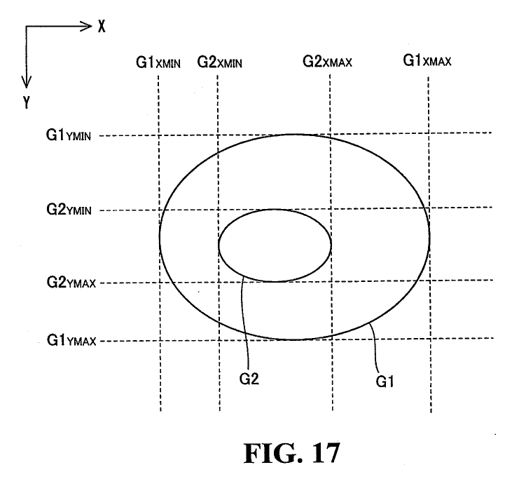

In step S9, the image processing processor 94 executes the overlap check processing of the particles. The image processing processor 94 is arranged with an overlap check circuit, and the overlap check processing is executed by the overlap check circuit. In the overlap check processing of the particles, the image processing processor 94 first determines whether or not another particle image (inner particle image) is contained in one particle image (outer particle image) based on the analysis result of the particle image by the edge trace processing. If the inner particle image exists in the outer particle image, the inner particle image is excluded from the cutout target of the partial image in the result data creating processing to be hereinafter described. The determination principle on whether or not the inner particle image exists will now be described. First, as shown in FIG. 17, two particle images G1 and G2 are selected, and the maximum value G1XMAX and the minimum value G1XMIN of the X coordinate and the maximum value G1YMAX and the minimum value G1YMIN of the Y coordinate of the particle image G1 are specified. The maximum value G2XMAX and the minimum value G2XMIN of the X coordinate and the maximum value G2YMAX and the minimum value G2YMIN of the Y coordinate of the particle image G2 are specified. The particle image G1 is determined as including the particle image G2 and the inner particle image is determined as existing when the following four conditions (condition (4) to condition (7)) are met.

Condition (4) . . . Maximum value G1XMAX of the X coordinate of the particle image G1 is greater than the maximum value G2XMAX of the X coordinate of the particle image G2.

Condition (5) . . . Minimum value G1XMIN of the X coordinate of the particle image G1 is smaller than the minimum value G2XMIN of the X coordinate of the particle image G2.

Condition (6) . . . Maximum value G1YMAX of the Y coordinate of the particle image G1 is greater than the maximum value G2YMAX of the Y coordinate of the particle image G2.

Condition (7) . . . Minimum value G1YMIN of the Y coordinate of the particle image G1 is smaller than the minimum value G2YMIN of the Y coordinate of the particle image G2.

The result data of the overlap check processing is stored in the internal memory (not shown) of the image processing processor 94.

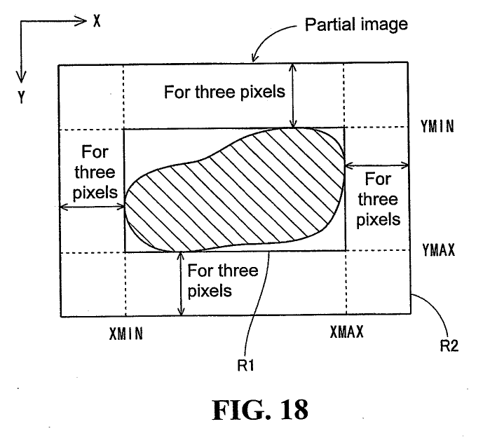

In step S10, the image processing processor 94 cutouts a partial image (see FIG. 18) individually including an individual particle image specified by the processing in steps S1 to S9 from the still image, and creates the image processing result data. The cutout of the partial image is performed based on the still image stored in the frame buffer 95, that is, the still image before binarization, and thus the partial image is the gray scale image. As shown in FIG. 18, the partial image is the image in which the rectangular region including one particle image and the region of the periphery of the particle image determined by the margin value set in advance is cutout from the still image. The rectangular region refers to a region R2 wider by three pixels each in the up and down, and left and right directions than a region R1 determined by the coordinate (YMIN) of the upper end, the coordinate (YMAX) of the lower end, the coordinate (XMIN) of the left end, and the coordinate (XMAX) of the right end of the particle image shown in FIG. 18.

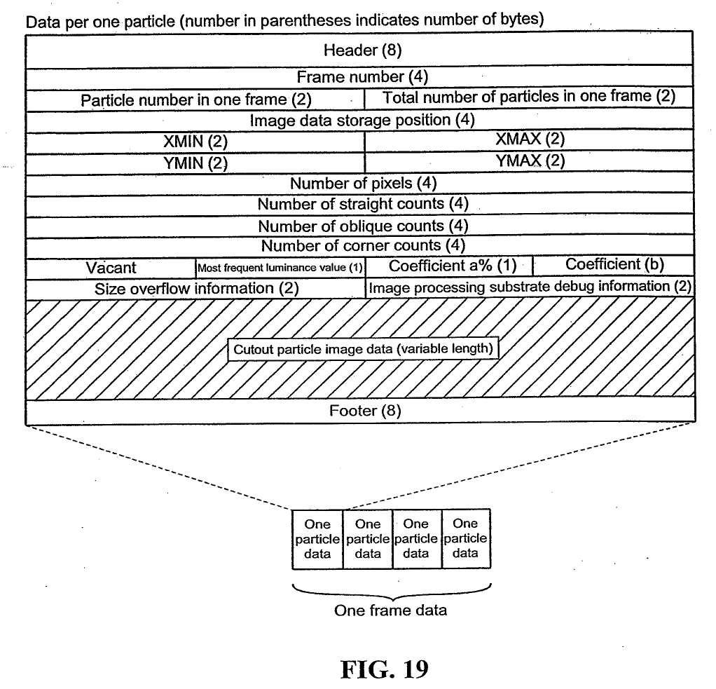

The image processing processor 94 is arranged with a result data creating circuit, and the result data creating circuit creates the result data based on the cutout partial image, as mentioned above. As shown in FIG. 19, the image processing result data includes, in addition to the image data of the partial image for all the particle images specified by the image processing in step S10 as mentioned above, and the data such as the area value (number of pixels), the number of straight counts, the number of oblique counts, and the number of corner counts of the particle image, the data (XMIN, XMAX, TMIN, and YMAX) of the position of the partial image including the particle image, and the data of the storage position of the image data. The image processing result data is generated for every one frame. The size of the image processing result data (one frame data) of one frame is a fixed length of 64 kilobytes. Thus, the size of one frame data does not change by the size of one image processing result data (one particle data) created for one partial image. One frame data is generated by being overwritten on the previous frame data. In one frame data shown in FIG. 19, each one particle data is very large, and thus only four particle data are embedded. When the one particle data length is small, or the number of particle data is small, the previous frame data may remain at the end of the one frame data since the data is embedded from the head of the one frame data. However, in the image data processing unit 2b of the transfer destination, one particle data in one frame data is recognized by the total number of particles in one frame stored in the one particle data, and thus the previous frame data remaining at the end will not be recognized. The image processing processor 94 stores the image processing result data created by the result data creating process in the result data storage memory 100. The image processing by the image processing processor 94 is terminated. The image processing processor 94 repeatedly executes a series of the above image processing by the pipeline processing, and performs the cutout of the partial image for every one frame and the generation of the image processing result data for 3600 frames. If the particle image does not exist in one frame, the head data of the one particle data in one frame shown in FIG. 19 is overwritten, and the particle information between the header and the footer is filled with “0”.

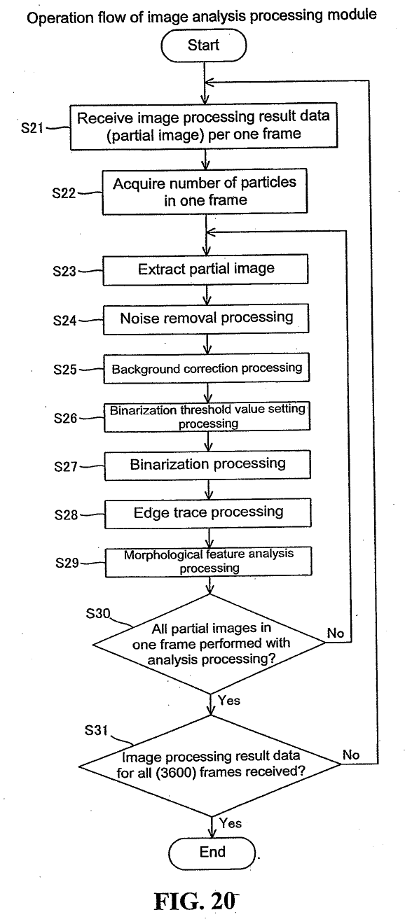

FIG. 20 is a flowchart showing the operation procedures of the image analysis processing module of the image data processing unit according to the first embodiment shown in FIG. 9. The operation of the analysis processing of the partial image by the image data processing unit 2b of the image data processing device 2 will now be described with reference to FIG. 20.

As described above, the application program (image analysis processing module) for performing the analysis processing of the partial image is installed in the hard disc of the image data processing unit 2b. The analysis processing of the partial image by the image analysis processing module is executed. In the analysis processing operation of the partial image, the image data processing unit 2b first receives the image processing result data (include partial image) for one frame in step S21 shown in FIG. 20. The number of particles in the received image processing result data for one frame is acquired in step S22.

In step S23, the image data processing unit 2b extracts the partial image contained in the image processing result data for one frame based on the image data storage position. The image data processing unit 2b then executes the noise removal processing and the background correction processing in steps S24 and S25 for each extracted partial image. The processing of steps S24 and S25 are similar to steps S1 and S2 in the processing procedure flow of the image processing processor 94 shown in FIG. 10, and thus detailed description will be omitted.

The image data processing unit 2b then executes the binarization threshold value setting processing on the partial image executed with each processing of step S24 and step S25. First, the image data processing unit 2b creates a luminance histogram (see FIGS. 12 and 13) from the partial image after the background correction processing. The image data processing unit 2b performs a predetermined smoothing processing on the luminance histogram. With regards to the partial image by the bright-field illumination, the most frequent luminance value of the partial image is obtained from the luminance histogram after the smoothing processing, and thereafter, the binarization threshold value is calculated by the following equation (5) by using the most frequent luminance value.

Binarization threshold value=most frequent luminance value of partial image×α(0<α<1)+β (5)

In equation (5), α and β are variables that can be set by the user, and the user can change the values of α and β depending on the measuring target. The default values of α and β are “0.9” and “0”, respectively.

In the first embodiment, the binarization threshold value is calculated as below for the partial image by the dark-field illumination. In other words, the most frequent luminance value is first obtained from the luminance histogram after the smoothing processing. The maximum luminance value of the partial image is obtained by referencing the luminance values of all the pixels of the partial image. The binarization threshold value is calculated by the following equations (6) and (7) by using the most frequent luminance value of the partial image and the maximum luminance value of the partial image.

Binarization threshold value=most frequent luminance value of partial image+maximum luminance value of partial image×γ(0<γ<1) (6)

Binarization threshold value=most frequent luminance value of partial image+δ (7)

Equation (6) is applied in the case of maximum luminance value of partial image×γ>δ, and equation (7) is applied in the case of maximum luminance value of partial image×γ≦δ. That is, the binarization threshold value is essentially calculated from equation (6), if the calculation value of equation (6) becomes smaller than the calculation value of equation (7) as the particle image of the partial image is dark, the calculation value of the equation (7) is set as the binarization threshold value. In equations (6) and (7), γ and δ are variables that can be set by the user, and the user can change the values of γ and δ depending on the measuring target. The threshold value for extracting the particles can be calculated in accordance with the luminance (brightness) of each particle by calculating the binarization threshold value by equation (6).

In step S5, the image data processing unit 2b performs the binarization processing on the partial image after the background correction processing at the threshold level (binarization threshold value) set in the binarization threshold value setting processing. That is, a collection of pixels having a luminance value smaller than the value calculated in equation (5) is extracted as a particle image with respect to the partial image by the bright-field illumination. A collection of pixels having a luminance value greater than the value calculated in equation (6) or equation (7) is extracted as a particle image with respect to the partial image by the dark-field illumination.

In step S28, the image data processing unit 2b executes the edge trace processing on the partial image of after the binarization processing. The edge trace processing is similar to step S8 in the processing procedure flow of the image processing processor 94 shown in FIG. 10, and thus detailed description will be omitted.

In step S29, the image data processing unit 2b generates morphological feature information of the particle based on the particle image contained in the partial image after the edge trace processing. The morphological feature information specifically includes circle equivalent diameter or degree of circularity. The circle equivalent diameter refers to the diameter of the circle having the same area as the projecting area of the particle image. The degree of circularity is a value indicating how much the shape of the particle image is close to a perfect circle, and is closer to a perfect circle the more the value of the degree of circularity is closer to one. The morphological feature information is generated for every extracted particle image, and the generated morphological feature information is stored in the storage device (not shown) in the image data analyzing device 2.

In step S30, whether or not all the partial images for one frame are performed with the analysis processing is judged. If judged that all the partial images for one frame are not performed with the analysis processing in step S30, the process returns to step S23, and another partial image is extracted from the image processing result data for one frame based on the image data storage position (see FIG. 19). If judged that all the partial images for one frame are performed with the analysis processing in step S30, the process proceeds to step S31. In step S31, whether or not the image processing result data is received for all (3600) frames is judged. If judged that the image processing result data is not received for all frames in step S31, the process returns to step S21, and the image processing result data for another frame is received. If judged that the image processing result data is received for all frames in step S31, the process is terminated. The image analysis processing of the partial images for 3600 frames obtained by imaging of particles for 60 seconds is then terminated.

In the first embodiment, the binarization threshold value is set for every partial image by equation (5). Thus, the threshold value for extracting the particle can be calculated for every particle, and if the imaged image obtained from one sample includes a particle image of large luminance and a particle image of small luminance, the threshold values suited for such particle images can be respectively set. Since the particle image having different luminance can be extracted based on the threshold value set for every particle, the particle images of both the particle image of large luminance and the particle image of small luminance can be extracted at high accuracy.

In the first embodiment, if the particle contained in the sample is transparent or translucent as a result of performing the dark-field illumination on the particle, a clear particle image can be obtained compared to the case of performing the bright-field illumination.

In the first embodiment, the binarization threshold value is calculated by equation (5). The most frequent luminance value in the partial image corresponds to the luminance value of the background in the partial image, and thus the portion of the partial image having a luminance larger than the luminance value of the background by a predetermined luminance value (maximum luminance value in partial image×γ) corresponding to the luminance of the particle can be extracted as the particle image.

In the first embodiment, with respect to the partial image obtained by the dark-field illumination, the particle image is extracted from the imaged image with the value calculated by equation (7) as the binarization threshold value if the value calculated by equation (6) is smaller than the value calculated by equation (7). According to such configuration, if the threshold value calculated by equation (6) becomes too small as the luminance of the particle image is small, the particle image can be extracted with the minimum threshold value calculated by equation (7) as the threshold value. Thus, the particle image can be extracted at high accuracy even if the value calculated by equation (6) becomes too small.

In the first embodiment, the morphological feature information of the particle can be generated based on the particle image extracted at high accuracy by generating the morphological feature information indicating the morphological feature of the particle based on the particle image extracted by the binarization threshold value set for every particle, and thus a more accurate morphological feature information can be generated.

### Second Embodiment

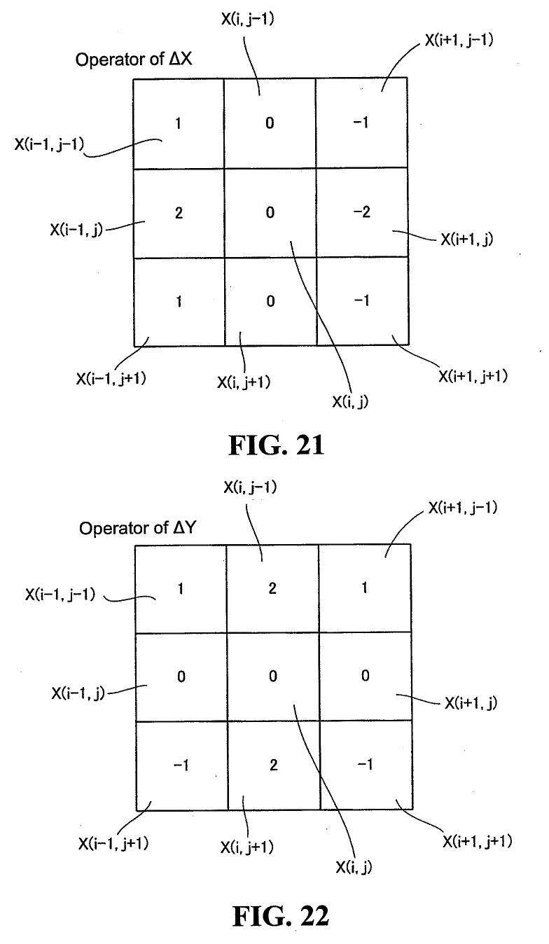

FIGS. 21 and 22 are views for describing a calculation method of a binarization threshold value of a particle analyzer according to a second embodiment of the present invention. In the second embodiment, an example of calculating the binarization threshold value based on the maximum value of the luminance gradient of the partial image will be described, as opposed to the first embodiment. The configuration other than the calculation method of the binarization threshold value is similar to the first embodiment, and thus the description will be omitted.

In the second embodiment, the binarization threshold value is set as below in the binarization threshold value setting processing of step S4 (see FIG. 10) and step S26 (see FIG. 20) of the first embodiment. The case of the bright-field illumination is similar to the first embodiment, and thus only the case of the dark-field illumination will be described.

First, the image data processing unit 2b creates a luminance histogram (see FIGS. 12 and 13) from the partial image after the background correction processing, and performs a predetermined smoothing processing on the luminance histogram. The most frequent luminance value is obtained from the luminance histogram after the smoothing processing. In the second embodiment, the luminance change (gradient of luminance value) in the pixel is obtained for all the pixels of the partial image. Specifically, the sum of the gradient AX of the luminance value in the X direction (horizontal axis direction) and the gradient ΔY of the luminance value in the Y direction (vertical axis direction) in the partial image of the pixel of interest is set as the gradient of the luminance value of the pixel of interest. Such gradients are calculated by Sobel operator shown in FIGS. 21 and 22. With respect to the gradient ΔX in the X direction (horizontal axis direction) of the pixel of interest, weighting as shown in FIG. 21 is carried out on the pixel of interest and the eight pixels at the periphery of the pixel of interest, and it is calculated as the sum of the luminance values of each weighted pixel. Therefore, the gradient ΔX of the luminance value in the X direction (horizontal axis direction) in the pixel of interest is calculated by the following equation (8) with the luminance value of the pixel of interest (i, j) as Y(i, j).

ΔX(i, j)=0×Y(i, j)+0×Y(i, j−1)+0×Y(i, j+1)+2×Y(i−1, j)+1×Y(i−1, j+1)+1×Y(i−1, j−1)−2×Y(i+1, j)−1×Y(i+1, j+1)−1×Y(i+1, j−1) (8)

Similarly, ΔY in the pixel of interest is calculated by the following equation (9) with the luminance value of the pixel of interest (i, j) as Y(i, j).

ΔY(i, j)=0×Y(i, j)−2×Y(i, j−1)+2×Y(i, j+1)+0×Y(i−1, j)+1×Y(i−1, j+1)−1×Y(i−1, j−1)+0×Y(i+1, j)+1×Y(i+1, j+1)−1×Y(i+1, j−1) (9)

The gradient G(i, j) in the pixel of interest (i, j) is calculated by equation (10) by using Δx(i, j) and ΔY(i, j).

G(i, j)=ΔX(i, j)+ΔY(i, j) (10)

The maximum value Gₘₐₓ of the gradient of the calculated gradient G of all pixels is determined. In the second embodiment, the binarization threshold value is calculated by the following equations (11) and (12) by using the most frequency luminance value of the partial image and the maximum value Gₘₐₓ of the gradient of the partial image.

Binarization threshold value=most frequent luminance value of partial image+maximum value Gₘₐₓ of gradient×ε(0<ε<1) (11)

Binarization threshold value=most frequent luminance value of partial image+δ(δ>0) (12)

Equation (11) is applied if maximum value Gₘₐₓ of gradient×ε>δ, and equation (12) is applied if maximum value Gₘₐₓ of gradient×ε≦δ. In equations (11) and (12), ε and δ are variables that can be set by the user, and the user can change the values of ε and δ depending on the measuring target. The threshold value for extracting the particle can be calculated in accordance with the luminance of each particle by calculating the binarization threshold value by equation (11).

In the second embodiment, the most frequent luminance value in the partial image is the luminance value of the background of the partial image by calculating the threshold value by equation (11), and thus the portion of the partial image having a luminance larger than the luminance value of the background by a predetermined luminance value (maximum value of luminance gradient in partial image×ε) corresponding to the luminance of the particle can be extracted as the particle image.

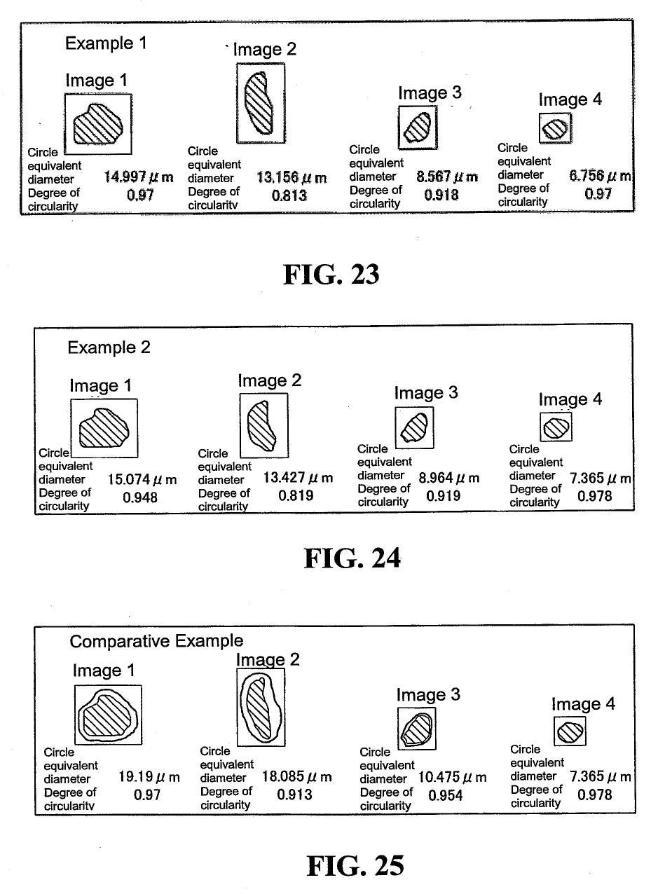

FIG. 23 is a view showing the particle image extracted based on the threshold value set by the binarization threshold value setting processing according to example 1 (first embodiment of the present invention), and the visual particle image. FIG. 24 is a view showing the particle image extracted based on the threshold value set by the binarization threshold value setting processing according to example 2 (second embodiment of the present invention), and the visual particle image. FIG. 25 is a view showing the particle image extracted based on the threshold value set by the binarization threshold value setting processing according to a comparative example (one prior art example), and the visual particle image. The comparative experiment verifying the effects of the present invention will now be described with reference to FIGS. 13 and 23 to 25. The images 1 to 4 in FIGS. 23 to 25 are the particle images extracted from the partial image of the same particle. In the comparative experiment, a case where the particle image is extracted from the partial image obtained through imaging by performing the dark-field illumination will be described.

In the particle analyzer according to the comparative example, the binarization threshold value is calculated by equation (12) after obtaining the luminance histogram (see FIG. 13), different from the binarization threshold value setting processing of the first embodiment and the second embodiment.

Binarization threshold value=most frequent luminance value+η(η≧δ) (12)

With respect to the threshold value calculated by equation (12), the same value is set for the binarization threshold value for the image imaged from one sample, as opposed to the first embodiment and the second embodiment. Other configurations are the same as the first embodiment.

The imaging is performed on the sample of a standard particle (latex particle) having a substantially even particle diameter, and the variable η of equation (12) is set such that the particle image is extracted with the smallest error by the particle analyzer according to the comparative example. The average particle diameter of the sample is calculated based on the particle image extracted in the case of the set variable η.

The particle image is extracted by the binarization threshold value setting processing according to the first embodiment with respect to the same partial image and the average particle diameter of the particle image is calculated, and the variable β of equation (6) is set such that the calculated average particle diameter becomes a value close to the average particle diameter of the comparative example. Similarly, for the binarization threshold value setting processing according to the second embodiment, the variable ε of equation (11) is set such that the average particle diameter becomes a value close to the average particle diameter of the comparative example. The sample including various particles having different luminance values is imaged by the particle analyzer with the variables η, β and ε set as above. The particle image is then extracted based on the respective threshold values set by the binarization threshold value setting processing according to the first embodiment (example 1), the second embodiment (example 2), and the prior art example (comparative example) with respect to the obtained partial image. The morphological features (circle equivalent diameter and degree of circularity) of the particle are calculated based on the extracted particle image.

The particle image and the morphological features of example 1, example 2, and the comparative example are respectively shown in FIGS. 23, 24, and 25. In FIGS. 23 to 25, the brightness of the particle image is reduced in order of image 1 to image 4.

As shown in FIGS. 23 to 25, in the image 4 in which the brightness of the particle is the smallest, difference in the extraction result of the particle is not found between example 1, example 2, and the comparative example. In the image 3 in which the particle is brighter than in the image 4, an error occurs between the visual particle image (hatching portion) and the extraction result (thick solid line portion) in the comparative example. In other words, a range larger than the visual particle image is extracted as the particle image. In the image 3, error is not found between the particle image (hatching portion) and the extraction result (thick solid line portion) in examples 1 and 2. In the images 1 and 2 of the particle much brighter than the image 3, a range significantly larger than the visual particle image is extracted as the particle image in the comparative example, and thus the error is significantly shown. In examples 1 and 2, on the other hand, error is not found between the visual particle image and the extraction result.

With regards to the morphological features, in the image 4, a large difference is not found among example 1, example 2, and the comparative example. In the images 1 to 3, it is apparent that the circle equivalent diameter of the comparative example is large compared to the circle equivalent diameter of example 1 and example 2. In other words, in the images 1 to 3 of the comparative example, a range larger than the visual particle image is extracted as the particle image, and thus the circle equivalent diameter is assumed to have increased. In the images 1, 2, and 4 of the particle having a shape relatively close to a circle, a large difference is not found in the degree of circularity among example 1, example 2, and the comparative example. In the image 2 in which an elongate particle is imaged, on the other hand, a large difference is found between the degree of circularity of examples 1 and 2 and the degree of circularity of the comparative example. In other words, in the comparative example, as a result of extracting a range larger than the visual particle image as the particle image, the extracted particle image has a rounded shape, and thus the degree of circularity is assumed to have increased.

Therefore, in the comparative experiment, the particle image can be extracted without large error with the visual particle image for all images 1 to 4 having different brightness of particles in examples 1 and 2 where the binarization threshold value is set for every particle. A difference is found between the morphological feature of the comparative example in which a range larger than the visual particle image is extracted as the particle image and the morphological feature of examples 1 and 2. Therefore, the morphological features of examples 1 and 2 are assumed to indicate a value close to the actual morphological feature of the particle than the morphological feature of the comparative example.

The embodiments and examples disclosed herein are merely illustrative in all aspects and should not be recognized as being restrictive. The scope of the invention is defined by the claims rather than the description of the embodiments and the examples, and the meaning equivalent to the claims and all modifications within the scope are encompassed therein.

For instance, an example of setting the binarization threshold value for every particle when performing the dark-field illumination is shown in the first and the second embodiments and the examples, but the present invention is not limited thereto, an the binarization threshold value may be set for every particle even when performing the bright-field illumination.

In the second embodiment and the examples, an example of calculating the gradient of the luminance of the partial image by using the Sobel filter is described, but the present invention is not limited thereto, and other filters such as Prewitt filter or Roberts filter may be used.

In the present embodiment, an example of setting the binarization threshold value for every particle and binarizing the gray scale partial image including the partial image with the set threshold value to extract the particle is shown, but the present invention is not limited thereto. For instance, the partial image including the particle image may be a color image. When extracting the particle image from the color image, the particle image and the background may be distinguished based on the difference in tone. Specifically, when one of the components of RGB changes with exceeding a predetermined value between a certain pixel and an adjacent pixel, the boundary between the particle image and the background is recognized between such two pixels, and the particle image is extracted. In this case, the difference in tone with respect to the background is assumed to differ for every particle depending on the extent of illumination of the particle, and thus the amount of change in RGB upon recognizing as the boundary between the particle image and the background is set for every particle to thereby accurately extract the particle image depending on the luminance of the particle.

In the present embodiment, cutout from the still image to the partial image is performed in the image processing substrate 6, and the image processing result data including the cut out partial image is analyzed in the image data processing unit 2b, but the present invention is not limited thereto. For instance, for instance, the video signal obtained from the CCD camera 82 may be transmitted to the image data processing unit 2b, and generation of the still image, cutout of the partial image, and the analysis of the image processing result data including the cut out partial image may be performed in the image data processing unit 2b. That is, the function of the image processing substrate 6 may be performed in the image data processing unit 2b.

What is claimed is:

1. A particle analyzer comprising a controller, including a memory under control of a processor, the memory storing instructions enabling the processor to carry out operations, comprising:
acquiring extraction parameters for each particle based on each image of a particles;
extracting particle images from each image of a particles based on the extraction parameters obtained for each particle; and
analyzing particles based on the extracted particle image.

2. The particle analyzer of claim 1, wherein the image of a particle includes an image of a particle subjected to dark-field illumination.

3. The particle analyzer of claim 1, wherein the extraction parameter is a threshold value for distinguishing a pixel to be extracted and a pixel not to be extracted as part of the particle image from the image of a particle.

4. The particle analyzer of claim 3, wherein the step of acquiring the extraction parameter includes a step of acquiring the threshold value for each particle based on a maximum luminance value of the imaged image.

5. The particle analyzer of claim 4, wherein
the extracting step includes a step of extracting the particle image from the image of a particle by binarizing the image of a particle based on the threshold value; and
the extraction parameter acquiring step includes a step of acquiring the threshold value from equation (1):
Binarization threshold value=most frequent luminance value in image of a particle+maximum luminance value in image of a particle×set value A1 (0<A1<1) (1).

6. The particle analyzer of claim 5, wherein the extracting step includes a step of extracting the particle image from the image of a particle with a value acquired from equation (2) as a binarization threshold value when the threshold value acquired in the extraction parameter acquiring step is smaller than the value acquired from equation (2):
Binarization threshold value=most frequent luminance value in image of a particle+set value B (B>0) (2).

7. The particle analyzer of claim 3, wherein the extraction parameter acquiring step includes a step of acquiring the threshold value for each particle based on a maximum value of a luminance gradient in the image of a particle.

8. The particle analyzer of claim 7, wherein
the extracting step includes a step of extracting the particle image from the image of a particle by binarizing the image of a particle based on the threshold value; and wherein the extraction parameter acquiring step includes a step of acquiring the threshold value from equation (3):
Binarization threshold value=most frequent luminance value in image of a particle+maximum value of luminance gradient in image of a particle×set value A2 (0<A2<1) (3).

9. The particle analyzer of claim 8, wherein the extracting step includes a step of extracting the particle image from the image of a particle with a value acquired from equation (4) as a binarization threshold value when the threshold value acquired in the extraction parameter acquiring step is smaller than the value acquired from equation (4):
Binarization threshold value=most frequent luminance value in image of a particle+set value B (B>0) (4).

10. The particle analyzer of claim 1, wherein the particle includes a particle of transparent material or translucent material.

11. The particle analyzer of claim 1, wherein the analyzing step includes a step of generating morphological feature information indicating a morphological feature of the particle based on the extracted particle image.

12. The particle analyzer of claim 11, wherein the morphological feature information is degree of circularity or circle equivalent diameter.

13. The particle analyzer of claim 1 further comprising an imaging unit for imaging a sample containing a plurality of particles and acquiring a sample image, wherein
the operations further comprises the step of acquiring the image of a particle by generating an image including a single particle image from the sample image.

14. The particle analyzer of claim 13, wherein the step of acquiring the image of a particle includes a step of acquiring a plurality of the images of a particle based on one sample image when one sample image includes a plurality of particle images.

15. The particle analyzer of claim 13, wherein the step of acquiring the image of a particle comprising steps of:
specifying the particle image in the sample image; and
acquiring the image of a particle by cutting out a portion in the sample image including the specified particle image.

16. The particle analyzer of claim 15, wherein the step of specifying the particle image in the sample image includes a step of specifying the particle image by binarizing the sample image.

17. The particle analyzer of claim 16, wherein
the imaging unit is configured to acquire a plurality of sample images from the sample; and wherein
the step of binarizing the sample image includes a step of setting a binarization threshold value for each sample image, and a step of binarizing the sample image by the binarization threshold value set for each sample image.

18. A particle analyzer comprising:
an extraction parameter acquiring means for acquiring extraction parameters for each particle based on each image of a particle;
an extraction means for extracting particle images from the each image of a particle based on the extraction parameters obtained for each particle by the extraction parameter acquiring means; and
an analyzing means for analyzing particles based on the particle image extracted by the extraction means.

19. Method for analyzing particles comprising steps of:
acquiring extraction parameters for each particle based on each image of a particle;
extracting particle images from each image of a particle based on the extraction parameters obtained for each particle; and
analyzing particles based on the particle images extracted by the extraction means.

20. A computer program product comprising:
a computer readable medium; and
instructions, on the computer readable medium, adapted to enable a particle analyzer to perform operations, comprising steps of:
acquiring extraction parameters for each particle based on each image of a particle;
extracting particle images from each image of a particle based on the extraction parameters obtained for each particle; and
analyzing particles based on the particle images extracted by the extraction means.
